(19) United States
(12) Patent Application Publication
(10) Pub. No.: US 2006/0067261 A1
(43) Pub. Date: Mar. 30, 2006

(54) Base station apparatus comprising function for collecting information

(75) Inventor: Takashi Murakami, Kawasaki (JP)

Correspondence Address: SWIDLER BERLIN LLP, 3000 K STREET, NW, BOX IP, WASHINGTON, DC, 20007, US

(73) Assignee: Fujitsu Limited

(21) Appl. No.: 11/017,810

(22) Filed: Dec. 22, 2004

(30) Foreign Application Priority Data
Sep. 28, 2004 (JP) 2004-282834

(51) Int. Cl. H04B 7/00

(52) U.S. Cl. 370/310

(57) ABSTRACT

A fixed image requesting unit periodically requests an information resource system for a fixed image. The fixed image obtained from the information resource system is held in a fixed image holding unit. Upon receiving a connection request from a user equipment to the information resource system, the congestion state managing unit checks the use conditions of radio terminals in the information resource system. When the information resource system is not congested, the user equipment is connected to an arbitrary radio terminal which is not in a used state. When the information resource system is congested, the congestion state managing unit transmits to the user equipment the fixed image held in the fixed image holding unit.

### BACKGROUND OF THE INVENTION

1. Field of the Invention

The present invention relates to an information collecting system for collecting and providing of information requested by a user by using a wireless communication system, and to a base station apparatus used therefor.

2. Description of the Related Art

Conventionally, a technique for obtaining information of a desired area (e.g. weather, traffic condition or the like) is disclosed. However, there often are cases where the situation of the desired area can not be grasped precisely with character information or audio information such as by radio broadcasting.

In recent years, contrary to the above situation, it has been made possible to obtain a video image shot by a camera installed in a desired area in real time, as a transmission speed becomes higher. (see <Jpn. unexamined patent application publication No. 10-66058>, <Jpn. unexamined patent application publication No. 11-144192>, <Jpn. unexamined patent application publication No. 2001-155289> and <Jpn. unexamined patent application publication No. 2004-38866>)

However, in conventional techniques, in order to allow a user to access to an image providing device in a connection destination, it is needed that the user has the information (e.g. a telephone number or an address) for the access to the image providing device, or that a dedicated server computer or the like to connect between the user and the image providing device is needed. Further, there are some cases where an image can not be provided due to the congested state when many accesses are concentrated to a particular image providing device.

Also, these problems do not occur only in services of collecting and providing video image in real time, but it can occur widely in services of collecting and providing various kinds of information.

### SUMMARY OF THE INVENTION

It is an object of the present invention to enhance the convenience of a service of collecting and providing of information requested by a user. Especially, it is a concrete object of the present invention to provide a configuration that a user can access to an information providing device even when the user does not have information for accessing to the information providing device without a dedicated device for the access. Further, it is another concrete object of the present invention to provide a configuration that a user can be provided with information corresponding to the requested information even when an information providing device is in a congested state.

A base station apparatus of the present invention, which accommodates a user terminal in a wireless communication system, comprises a storing unit for storing connection destination information specifying an information providing device and a corresponding telephone number assigned to the information providing device, a detecting unit for detecting a service which is requested by a user using the user terminal based on a signal from the user terminal, a converting unit for converting the connection destination information included in a connection request received from the user terminal into a corresponding telephone number by referring to the storing unit when the user requests a predetermined service, and a call processing unit for connecting the user terminal and the information providing device by transmitting to a radio network controller the telephone number obtained by the conversion.

According to the present invention, connection destination information included in a connection request is automatically converted into a corresponding telephone number in a base station apparatus.

A base station apparatus of another aspect of the present invention, which accommodates an information resource system in a wireless communication system, comprises a managing unit for managing a congestion state of the information resource system, a holding unit for holding auxiliary resource related to information resource provided by the information resource system, and a responding unit for connecting the user terminal to the information resource system when the information resource system is not in a congested state and for providing to the user terminal the auxiliary resource held in the holding unit when the information resource system is in a congested state.

According to the present invention, a congestion state of an information resource system is managed by the base station apparatus accommodating the corresponding information resource system. If the information resource system is in a congested state when there is a connection request made by a user terminal, the auxiliary resource corresponding to the information resource to be provided by the information resource system is provided by the base station apparatus, instead of the information resource to be provided by the information resource system.

According to one aspect of the present invention, connection destination information is converted into a corresponding telephone number by a base station apparatus so that a user can access to an information providing device even if he or she does not know the telephone number of the information providing device to be accessed.

Further, according to another aspect of the present invention, an auxiliary resource can be obtained even when an information resource system is in a congested state so that a conclusion that no information is given to a user due to a congested state can be avoided.

According to the above solutions, the convenience of the service for collecting and providing of information requested by a user is enhanced.

### BRIEF DESCRIPTION OF THE DRAWINGS

FIG. 1 is shows a configuration of a wireless communication system according to the present invention;

FIG. 2 shows processings performed when a user equipment receives a video image collection/delivery service;

FIG. 3 shows a data format of PRACH signal;

FIG. 4 shows a configuration of a base transceiver station;

FIG. 5 shows an example of a telephone number storing unit;

FIG. 6 shows sequence for the registration of information in a telephone number storing unit;

FIG. 7 shows a configuration of a wireless communication system according to another embodiment of the present invention;

FIG. 8 shows a configuration of a base transceiver station according to another embodiment of the present invention;

FIG. 9 shows an example of a congestion managing table; and

FIG. 10 is a flow chart showing processings in the base transceiver station shown in FIG. 8 at the time of terminating a call.

### DESCRIPTION OF THE PREFERRED EMBODIMENTS

The present invention relates to services for providing of information (or information resource) in response to a request by a user. Hereinafter, a service in which a video image requested by a user is collected and provided in real time will be described, as one example of the services.

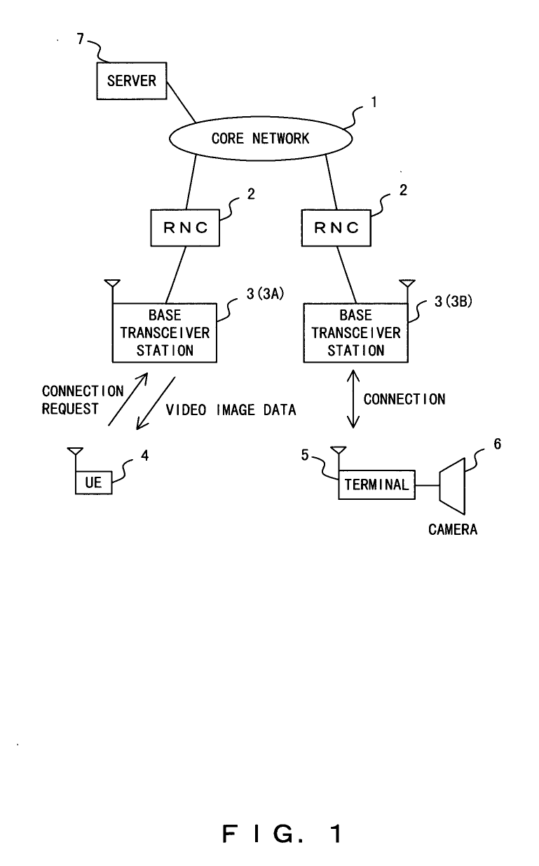

FIG. 1 shows a configuration of a wireless communication system according to the present invention. Here, W-CDMA (Wideband-Code Division Multiple Access) mobile communication system is described as one example of wireless communication systems. However, it is to be noted that the present invention is not limited to the W-CDMA mobile communication system.

Core network (CN) 1 comprises a switching station, a home location register, service controlling station and the like, and the core network 1 provides a circuit switching function and a packet switching function. A large number of radio network controllers (RNC) 2 are connected to the core network 1.

Each radio network controller 2 is provided with a function for processing control signals, an O&M function, a multiplexing and demultiplexing function for a common channel, an ATM switching function, hand-over function or the like. The radio network controller 2 conducts circuit connection control of wireless circuit, control of hand-over and the like. Also, one or a plurality of base transceiver stations 3 are connected to the radio network controller 2.

The radio base transceiver stations 3 (3A, 3B), which is a base station apparatus, transmits and receives call control signal to/from the radio network controllers 2, manages the wireless circuit and conducts setting up/releasing of the wireless circuit. Also, each radio base transceiver station 3 accommodates a user equipment (UE) 4 or a mobile terminal 5.

The user equipment 4, which is a mobile station, is a user terminal capable of high speed data transmission and transmits and receives a signal to/from the radio base transceiver station 3 through a wireless circuit. The mobile terminal 5 is apart of an information providing device for providing a video image and transmits and receives a signal to/from the radio base transceiver station 3 through a wireless circuit. The radio terminal 5 is connected to a camera 6 for outputting the video image and transmits corresponding video image data in response to a request from the user equipment 4. A server 7 is a computer for managing the correspondence relationship between the names of places at which cameras 6 are installed and telephone numbers of the radio terminals 5 connected to the cameras 6. The server 7 is run by, for example, a company for providing a video image collection/delivery service.

Further, only one camera 6 is shown in FIG. 1, however, a large number of cameras are installed at different areas respectively. And a radio terminal is connected to each camera so that a video image data output from the each camera is transmitted through the radio terminal in response to a user request. Also, a radio terminal 5 and a camera 6 can be included in one and the same device.

In the above system, the user equipment 4 transmits to the radio base transceiver station 3 a connection request by using a dedicated control channel (DCCH) in order to obtain a video image from the camera 6. In the connection request, a service information which indicates that the user equipment 4 needs to receive a video image collection/delivery service and a connection destination information specifying an information providing device which is to provide the video image needed by the user equipment 4 are set. Further, the connection destination information is not information directly specifying the radio terminal 5 connected to the camera 6 (e.g. a telephone number of the radio terminal), but information specifying a name of a place at which the camera 6 is installed.

When the radio base transceiver station 3 (the radio base transceiver station 3A in this example) receives the above connection request, the radio base transceiver station 3 detects service information. Then, if the service information indicates that the user equipment 4 needs to receive a video image collection/delivery service, the radio base transceiver station 3 converts “name of place” set as the connection destination information into a corresponding telephone number. Thereby, a telephone number of the radio terminal 5 is obtained. Thereafter, the radio base transceiver station 3 sets the telephone number of the radio terminal 5 as a destination number of the dedicated control channel (DCCH) in order to notify the radio network controller 2 of the telephone number of connection destination.

The core network 1 establishes a call connection to the specified radio terminal 5. The radio terminal 5 transmits to the user equipment 4 video image data output from the camera 6. Thereby, the user equipment 4 can obtain video image data output from the camera 6 in real time.

As described above, a user of the user equipment 4 can obtain a video image of a desired area in real time by specifying “name of place” of an area from which a user wants to obtain the video image. In other words, the radio base transceiver station 3 is provided with a function for converting the “name of place” into a corresponding telephone number so that a user do not have to be conscious of a telephone number of the radio terminal 5 connected to the camera 6 in order to obtain a video image from the desired camera in real time.

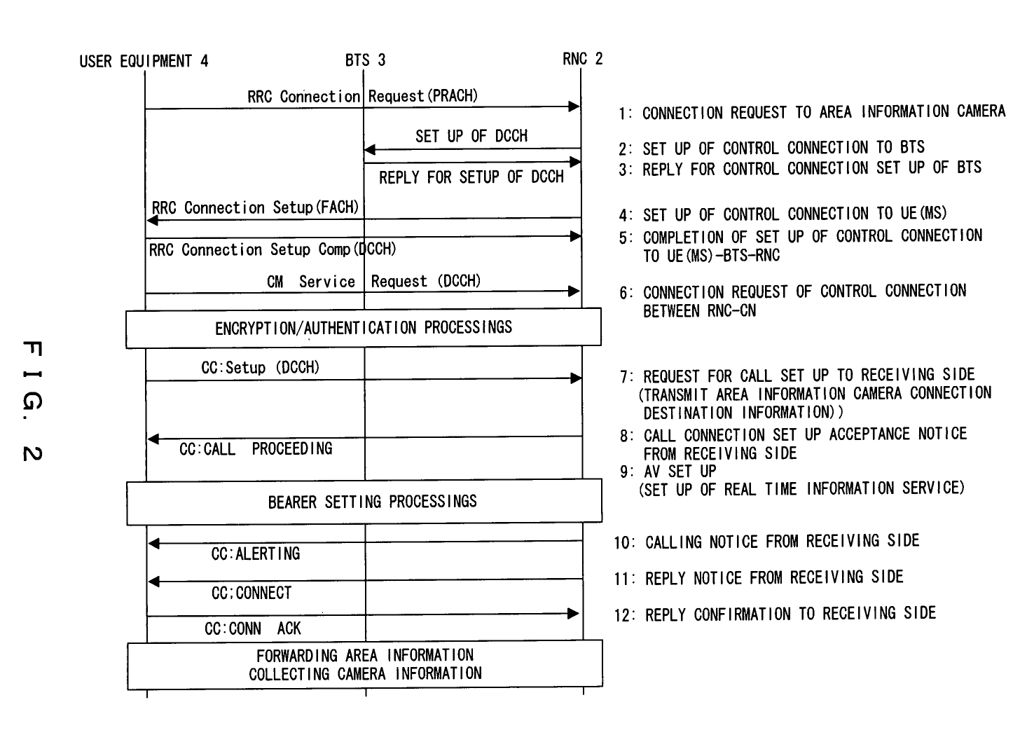

FIG. 2 shows processings conducted when the user equipment 4 receives a video image collection/delivery service. Herein, signals transmitted/received by the user equipment 4, the radio base transceiver station 3 and the radio network controller 2 are shown.

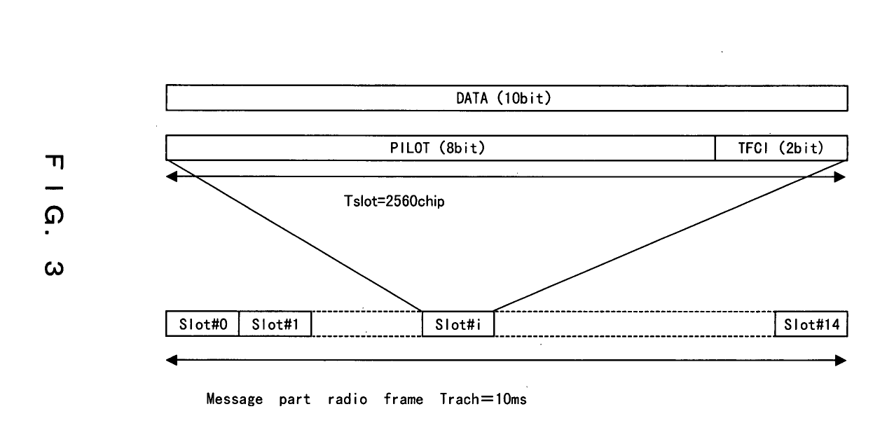

First, the user equipment 4 transmits a connection request (RRC) to the radio network controller 2 by using a physical random access Channel (PRACH). The PRACH signal is based on a format shown in FIG. 3 and a value indicating that the user equipment 4 needs to receive a video image collection/delivery service (for example, 0x3FF(hex)) is set in the signal as a data to be stored in a predetermined slot. The radio base transceiver station 3 can recognize the request of the video image collection/delivery service by the user equipment 4 according to the PRACH signal.

The radio network controller 2, when receiving the above connection request, transmits to the radio base transceiver station 3 a message for setting up a dedicated control channel (DCCH). The radio base transceiver station 3 returns a corresponding reply message. Next, the radio network controller 2 transmits to a user equipment 4 a message for setting up a dedicated control channel (RRC: Connection Setup) by using a forward access channel (FACH). The user equipment 4 returns a corresponding reply message (RRC Connection Setup Comp) by using a dedicated control channel (DCCH). Further, the user equipment 4 transmits a setup request (CM Service Request) to set up a control connection between the radio network controller 2 and the opposite terminal by using the dedicated control channel (DCCH).

After the encryption/authentication processings are performed, the user equipment 4 transmits a message requesting a call setup (CC: Setup) to the receiving side by using the dedicated control channel (DCCH). In this message, “name of place” from which a user wants to obtain the video image is included as a connection destination information. And the radio base transceiver station 3 once holds this message. Then, if the radio base transceiver station 3 recognizes the request of a video image collection/delivery service by the user equipment 4, the radio base transceiver station 3 forwards a telephone number corresponding to the name of the place set in the message to the radio network controller 2, after converting the name of the place into a corresponding telephone number.

The radio network controller 2 returns a call setup reception notification (CC:CALL PROCEEDING) from the receiving side to the user equipment 4. Thereafter, processings for bearer setting is conducted.

Further, a calling notice (CC:ALERTING) and a reply notice (CC:CONNECT) a retransmitted to the user equipment 4. Then, the user equipment 4 returns a reply confirmation (CC:CONN ACK). Thereby, a connection is established between the user equipment 4 and the correspondence terminal (the radio terminal 5 in the example shown in FIG. 1) and a video image data output from the camera 6 is transmitted to the user equipment 4 through the connection.

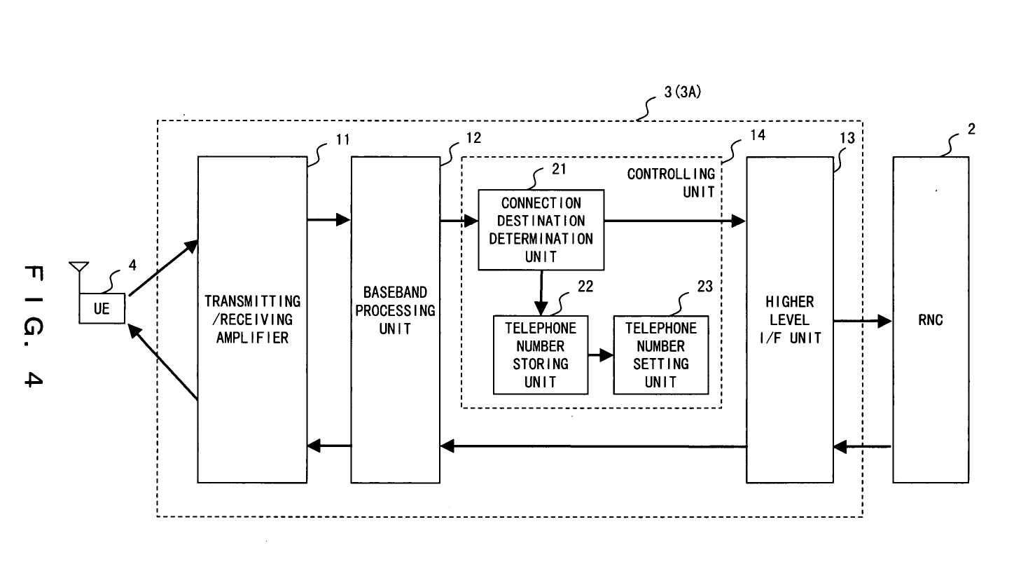

FIG. 4 shows a configuration of the radio base transceiver station 3. Herein, the radio base transceiver station 3A accommodating the user equipment 4 in FIG. 1 is shown.

A transmitting/receiving amplifier 11 comprises a transmission power amplifier for amplifying a signal to be transmitted to a user equipment or a radio terminal, and a low noise amplifier for amplifying a received signal. A baseband processing unit 12 comprises a transmitting unit for conducting error correcting coding, framing, data modulation, and spread modulation, for transmitting signals, and a receiving unit for conducting despreading, chip synchronization, error correcting decoding, data multiplexing/demultiplexing, signal processings for hand-over for received signals. Further, in FIG. 4, the baseband processing unit 12 includes an A/D converter and a D/A converter. A higher level I/F unit 13 processes signals transmitted and received to/from the radio network controller 2. Incidentally, examples of the transmission paths between the radio base transceiver station 3 and the radio network controller 2 is an ATM transmission path. Controlling unit 14 transmits and receives a call control signal to/from the radio network controller 2, manages the wireless circuit and conducts setting up/releasing of the wireless circuit and the like.

A connection destination determination unit 21 analyzes a connection request from the user equipment 4 in order to determine whether the user equipment 4 requests a normal service (AV, PKT, AMR or the like) or a video image collection/delivery service relating to the present invention. When the user equipment 4 requests the normal service, the connection destination determination unit 21 forwards the received connection request to the higher level I/F unit 13. To the contrary, when the user equipment 4 requests the video image collection/delivery service, the connection destination determination unit 21 searches a telephone number storing unit 22 using the “name of place” set in the received connection request as a search key in order to obtain the corresponding telephone number.

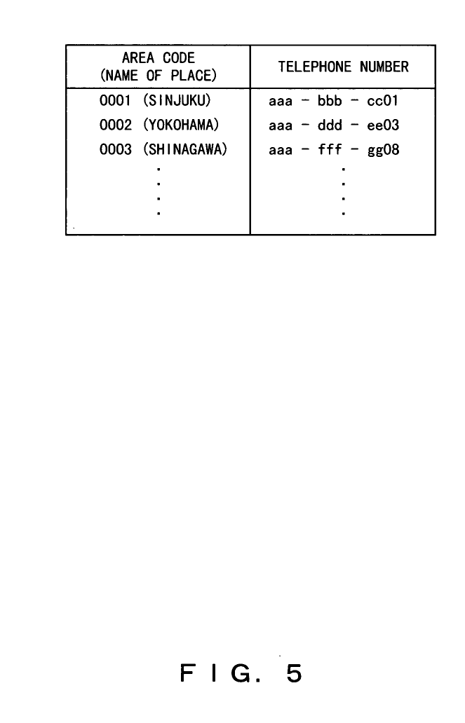

FIG. 5 shows an example of a telephone number storing unit 22. In the telephone number storing unit 22, the names of places (in practice, area codes in a predetermined number of bits) at which the cameras are installed for the video image collection/delivery service and corresponding telephone numbers of the radio terminals connected to respective cameras are registered. For example, if the camera 6 in FIG. 1 is installed at “SHINJUKU”, the telephone number of the radio terminal 5 connected to the camera 6 is “aaa-bbb-cc01”. The sequence for registering information in the telephone number storing unit 22 will be described later.

The telephone number setting unit 23 extracts the “telephone number” from the telephone number storing unit 22, sets the extracted “telephone number” in the connection request received from the user equipment 4 and sends the “telephone number” to the higher level I/F unit 12. Thereby, a call connection processing to the terminal assigned the telephone number corresponding to the “name of place” set in the connection request from the user equipment 4 is conducted.

The connection destination determination unit 21, the telephone number storing unit 22 and the telephone number setting unit 23 can be implemented as parts of the controlling unit 14 or can be implemented independently from the controlling unit 14. The telephone number storing unit 22 is provided on RAM or the like. The connection destination determination unit 21 and the telephone number setting unit 23 can be implemented as hardware or as software or as a combination of hardware and software.

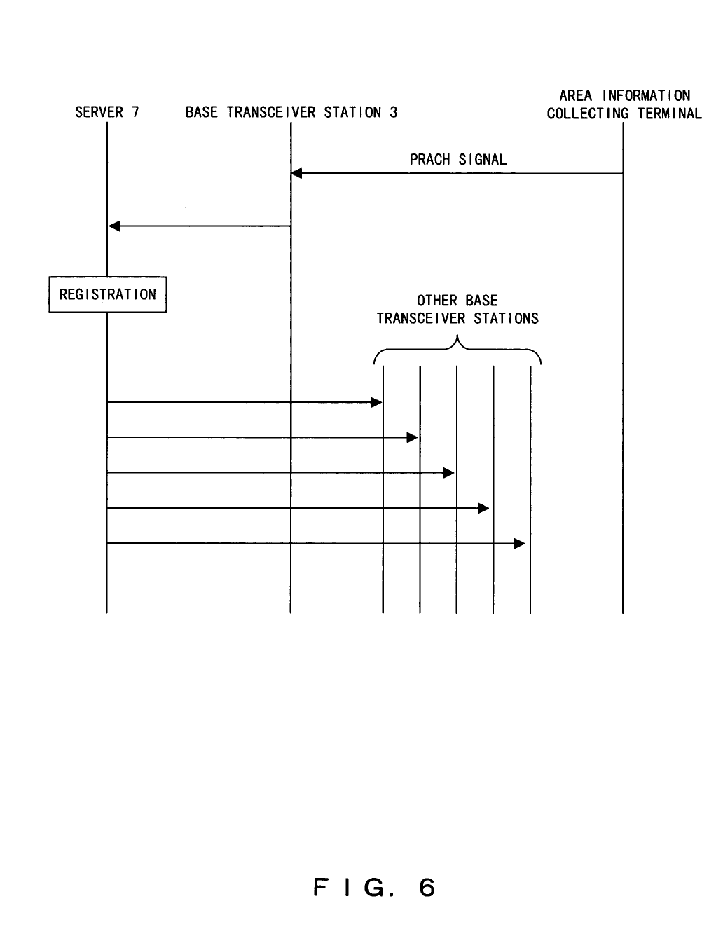

FIG. 6 shows sequence for the registration of information in a telephone number storing unit 22. Herein, a case where a camera for the video image collection/delivery service is newly installed will be explained.

An area information collecting terminal connected to the newly installed camera (the radio terminal 5 in FIG. 1 for example) transmits a PRACH signal to the nearest radio base transceiver station 3. In the PRACH signal, identification information indicating that the terminal transmitting the PRACH signal is a terminal for an area information collecting camera, and the telephone number information of the terminal are included.

The radio base transceiver station 3 transmits to server 7 information extracted from the received PRACH signal. The server 7 registers the telephone number of the area information collecting terminal and establishes a link between the telephone number of the terminal and the “name of place” of the place at which the area information collecting terminal is installed. The server 7 transmits the link information to all of the radio base transceiver stations 3. Thereby, link information between the “name of place” of a place at which the camera is installed and a telephone number of the radio terminal connected to the camera is registered in the telephone number storing unit 22 of each radio base transceiver stations 3. The contents of the server 7 are published by a company for providing the video image collection/delivery service.

When an area information collecting terminal is removed or a telephone number thereof is changed, the fact is notified to the server 7, which configuration is not shown in the figure. Each telephone number storing unit 22 is updated based on the instruction transmitted from the server 7 to each radio base transceiver station 3.

When a user needs to receive a video image collection/delivery service, the user accesses, for example, to the server 7 by using user equipment 4. Then, a list including names of all of the places at which cameras for the video image collecting/delivery service are installed is displayed on the user equipment 4. When the user selects a name of a desired place from the list, the user equipment 4 automatically makes the connection request to be transmitted to the nearest radio base transceiver station 3. Upon this processing, a “name of a place” selected by the user is set in the above connection request. Thereby, an video image from the camera installed at an area corresponding to the “name of place” selected by the user is delivered to the user equipment 4 in real time.

As described above, a user of the user equipment 4 can collect an image of a desired area in real time without a consciousness of a telephone number of the area information collecting terminal. By the time of this processing, the telephone number of the area information collecting terminal as a connection destination has been stored in advance in the radio base transceiver station 3, so that the radio base transceiver station 3 having received the connection request can conduct a call connection processing instantly. Therefore, according to a system of the present invention, the user equipment 4 can obtain an image in real time with a shorter waiting time in comparison with (1) a system in which the user equipment 4 makes a call to an area information collecting terminal after obtaining a telephone number of an area information collecting terminal from the server 7 and with (2) a system in which a server 7 makes a call to a specified area information collecting terminal in accordance with a request from the user equipment 4.

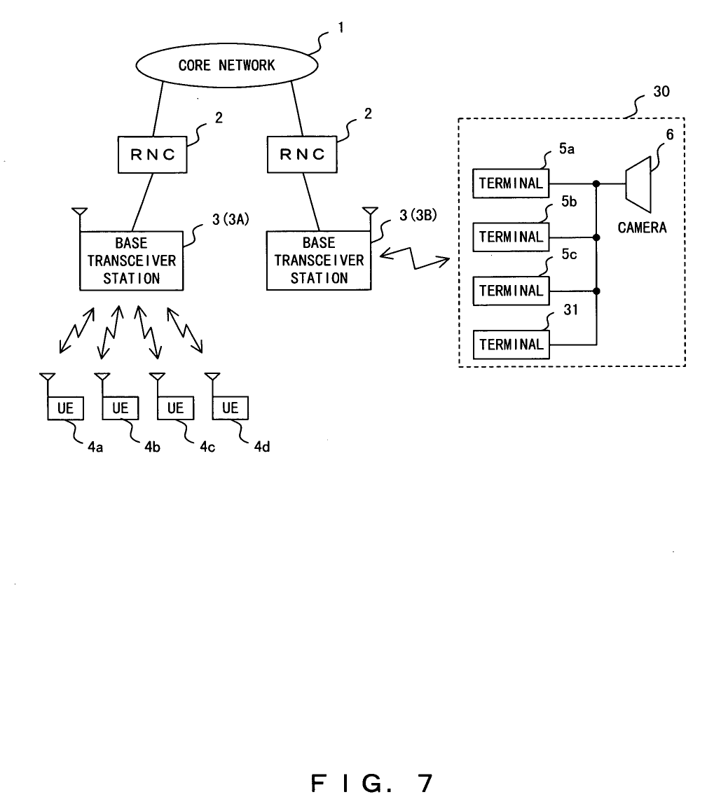

FIG. 7 shows a configuration of a wireless communication system according to another embodiment of the present invention. Herein, the core network 1, the radio network controllers 2 and the camera 6 are respectively the same devices as explained in FIG. 1. Also, each of a plurality of user equipments 4a through 4d is the same with the user equipment 4, and each of a plurality of radio terminals 5a through 5c is the same with the radio terminal 5. However, different telephone numbers are assigned to the plurality of the radio terminals 5a through 5c, respectively.

An information resource system 30 includes the radio terminals 5a through 5c, a radio terminal 31 and the camera 6, and provides an information resource requested by a user. In this example, video image data output from the camera 6 is provided as the information resource. Further, three radio terminals 5a through 5c are connected to the camera 6, and the information resource system 30 can provide the same video image to three users in parallel.

The radio terminal 31 transmits an auxiliary resource related to information resource to be provided by the information resource system 30 in response to a request from a nearest radio base transceiver station 3 (radio base transceiver station 3B in FIG. 7). The auxiliary resource is, for example, a fixed image data (that is still image) obtained by capturing the video image output from the camera 6.

The radio base transceiver station 3 periodically requests the information resource system 30 for the auxiliary resource by using a broadcast channel (PCCPCH: Primary Common Channel Physical Channel). The radio terminal 31 creates a fixed image by capturing a video image output from the camera 6, when receiving the above request. Then, the radio terminal 31 transmits the fixed image to the radio base transceiver station 3 by using a physical common packet channel (PCPCH) for a high speed packet data transmission. Thereby, the radio base transceiver station 3 can periodically obtain the fixed image from the information resource system 30.

In the above system, the sequence for obtaining a video image from the camera is basically the same as explained by referring to the FIG. 1. That is, the user equipments 4a through 4d transmit connection requests to the radio base transceiver station 3. And the core network 1 starts establishing the call connection to the information resource system 30.

In this sequence, the radio base transceiver station 3 accommodating the information resource system 30 checks the congestion level of the information resource system 30. Specifically, the radio base transceiver station 3 checks the use conditions of the radio terminals 5a through 5c. And when one or more of the radio terminals 5a through 5c are not in busy state, the radio base transceiver station 3 connects the user equipment 4 requesting the video image collection/delivery service and an arbitrary radio terminal which is not in busy sate. Thereby, a video image output from the camera 6 is provided to the user equipment.

To the contrary, when all of the radio terminals 5a through 5c are in busy state, the radio base transceiver station 3 transmits to the user equipment a fixed image which has been obtained in advance from the information resource system 30. In this case, the user equipment which requested the video image collection/delivery service can obtain a fixed image corresponding to the requested video image, although the user equipment can not obtain the video image itself. In other words, a conclusion that no information is given to the user can be avoided, even when the information resource system 30 is congested.

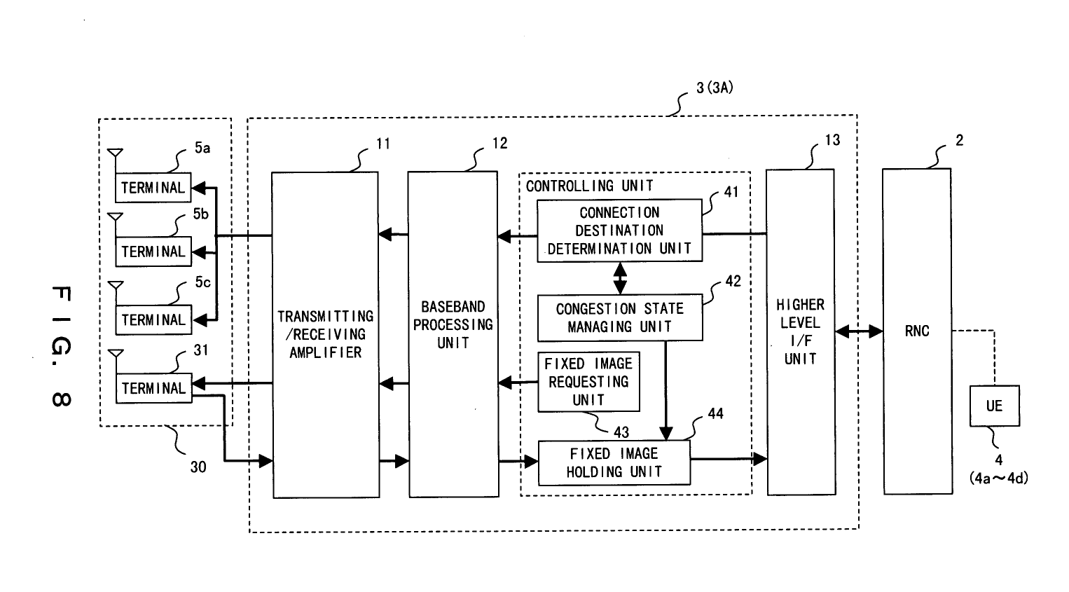

FIG. 8 shows a configuration of a radio base transceiver station 3 according to another embodiment of the present invention. Here, the radio base transceiver station 3B accommodating the information resource system 30 of FIG. 7 is shown.

A connection destination determination unit 41 checks whether or not the connection destination notified from the radio network controller 2 is the information resource system 30. If the connection destination is not the information resource system 30, normal call processing is conducted. To the contrary, the connection destination is the information resource 30, the connection request is sent to a congestion state managing unit 42.

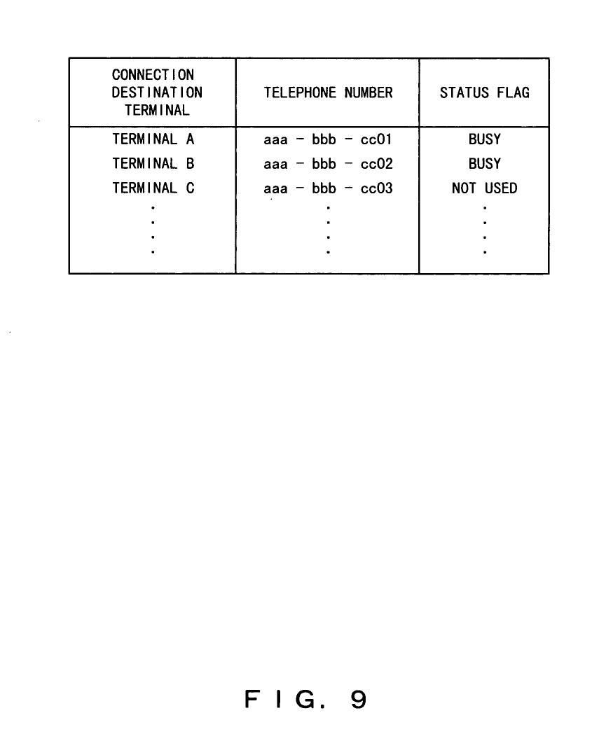

The congestion state managing unit 42 includes a congestion managing table shown in FIG. 9 and manages use conditions of the radio terminals 5a through 5c. Specifically the congestion state managing unit 42 changes a corresponding status flag of “NOT USED” into “BUSY” when a new call is connected to one of the radio terminals 5a through 5c, and changes the corresponding flag of “BUSY” into “NOT USED” when a communication using one of the radio terminals 5a through 5c is terminated and the call is released. And when there is at least one radio terminal which is not in busy state, the congestion state managing unit 42 selects the telephone number of one arbitrary terminal to notify the telephone number to the connection destination determination unit 41. Thereby, a radio terminal with the selected telephone number is called and a video image is transmitted from the radio terminal. To the contrary, when there is not a radio terminal which is not in busy state, the congestion state managing unit 42 notifies the fact that a congestion state has occurred to the fixed image holding unit 44.

The fixed image requesting unit 43 periodically requests the radio terminal 31 of the information resource system 30 for a fixed image by using a broadcast channel PCCPCH. Then the radio terminal 31, having received the above request, transmits to the radio base transceiver station 3 a fixed image obtained by capturing a video image output from the camera 6 by using a physical common packet channel PCPCH for high speed packet data.

The fixed image holding unit 44 holds a latest fixed image transmitted from the radio terminal 31. When the fixed image holding unit 44 is notified of the fact that a congestion state has occurred by the congestion state managing unit 42, the fixed image holding unit 44 forwards the held fixed image to the higher level I/F unit 13. Thereby, the higher level I/F unit 13 transmits the fixed image to the user equipment requesting the video image collection/delivery service.

As described above, the user equipments 4a through 4d can obtain a video image output from the camera 6 in real time while the information resource system 30 is not congested. To the contrary, when the information resource system 30 is congested, the user equipments 4a through 4d can obtain a fixed image corresponding to the requested video image, although the user equipment can not obtain the requested video image itself.

The connection destination determination unit 41, the congestion state managing unit 42, the fixed image requesting unit 43 and the fixed image holding unit 44 can be implemented as parts of the controlling unit 14 or can be implemented independently from the controlling unit 14. In addition, the connection destination determination unit 41, the congestion state managing unit 42 and the fixed image requesting unit 43 can be implemented as hardware or as software or as a combination of hardware and software. Further, the fixed image holding unit 44 comprises a rewritable storage area.

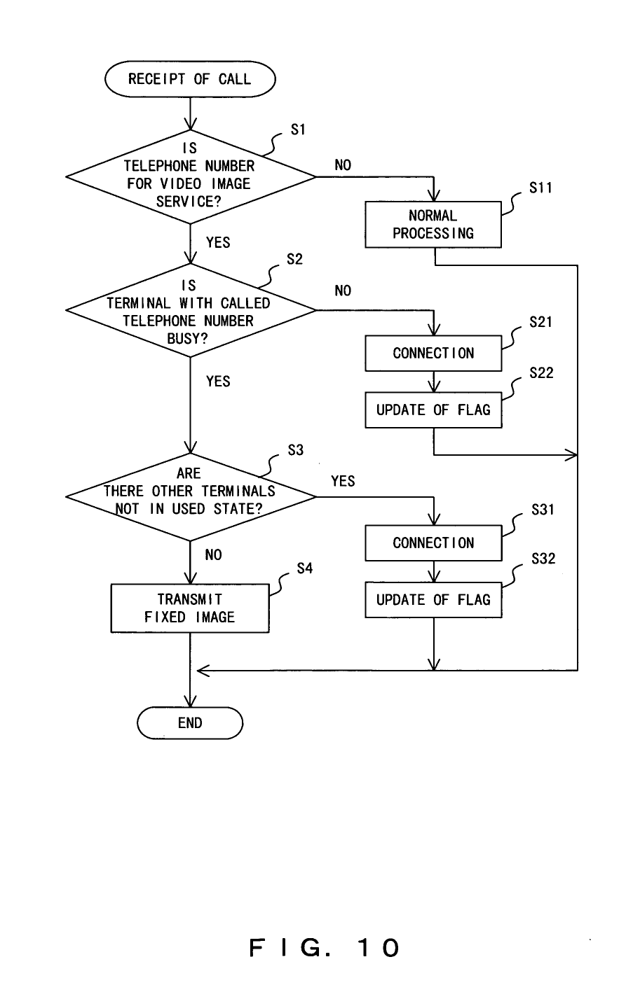

FIG. 10 is a flow chart showing a sequence at the time of receiving a call in the radio base transceiver station 3 shown in FIG. 8. The processings shown in this flow chart are implemented by the connection destination determination unit 41, the congestion state managing unit 42 and the fixed image holding unit 44.

In step S1, it is determined whether or not a called telephone number is for the video image collection/delivery service. If the called telephone number is not for the video image collection/delivery service, a normal call processing is conducted in step S11.

In step S2, it is determined whether or not the radio terminal with the called telephone number is in a used state by referring to the congestion managing table of FIG. 9. If the radio terminal with the called telephone number is not in a used state, the user equipment requesting the video image collection/delivery service is connected to the radio terminal on which the called telephone number is assigned in step S21. Further, in step S22, the corresponding status flag in the congestion managing table is updated from “NOT USED” into “BUSY”.

If the radio terminal with the called telephone number is busy, it is checked whether or not there is a radio terminal which is not busy. Then, if there is a radio terminal not in busy state, the user equipment requesting the video image collection/delivery service is connected to an arbitrary radio terminal which is not in busy state, in step S31. Further, in step S32, the corresponding status flag in the congestion managing table is updated from “NOT USED” into “BUSY”.

If there is not a radio terminal which is not in busy state, a processing in step S4 is conducted assuming that the information resource system is congested. In step S4, a fixed image which is held in the fixed image holding unit 44 is transmitted to the user equipment requesting the video image collection/delivery service.

When a communication between the user equipment 4 (4a through 4d) and the information resource system 30 is terminated, the corresponding status flag in the congestion managing table is updated from “BUSY” into “NOT USED”.

A concrete example will be explained, referring to FIG. 7. Herein, it is assumed that the user equipment 4a is now receiving a video image through the radio terminal 5a. And also, it is assumed that the radio terminals 5b and 5c are not in a used state. Further, in FIG. 7, the user equipments 4a through 4d are accommodated in one and the same radio base transceiver station 3A, however, these user equipments can separately be accommodated in different radio base transceiver stations.

In a situation such as above, when the radio base transceiver station 3B receives a connection request from the user equipment 4b to the radio terminal 5b, the radio base transceiver station 3B connects the user equipment 4b to the radio terminal 5b. Thereby, the user equipment 4b can receive a video image output from the camera 6 in real time.

Next, when the radio base transceiver station 3B receives a connection request from the user equipment 4c to the radio terminal 5a, the radio base transceiver station 3B converts the telephone number of the radio terminal 5a as the call destination into the telephone number of the radio terminal 5c and performs paging. Thereby, the user equipment 4c is connected to the radio terminal 5c. In other words, the user equipment 4c receives a video image output from the camera 6 through the radio terminal 5c in real time. Thereby, the user equipment 4c can receive the video image collection/delivery service without a consciousness of use condition of the radio terminals 5a through 5c.

Further, when the radio base transceiver station 3B receives a connection request from the user equipment 4d to the radio terminal 5a in a period during which all the radio terminals 5a through 5c are busy, the radio base transceiver station 3 transmits to the user equipment 4d a fixed image which have been obtained from the information resource system 30 in advance.

It is to be noted that a system according to the present invention is not limited to the above examples but can be applied to the following applications.
(1) An application as a security system, in which the area information collecting camera is installed at a dwelling so that the image by the camera is obtained from the outside.
(2) An application as the media replacing TV broadcasting, in which the area information collecting camera is used for the broadcasting of sport events, plays, music concerts or the like.
(3) An application in which the area information collecting camera is downsized and sold for individual persons in order to be used for distributing personal information so that an individual person can open a service station with a low cost.
(4) An application in which, when a disaster or the like occurs, the extent of damage of the damaged area is simultaneously distributed to a plurality of user equipments, by the broadcast transmissions.
(5) Further, the present invention can be applied to other services than a service in which an image shot by a camera is collected and supplied in real time.

What is claimed is:

1. A base station apparatus accommodating a user terminal in a wireless communication system, comprising:
a storing unit for storing connection destination information specifying an information providing device and a corresponding telephone number assigned to the information providing device;
a detecting unit for detecting a service which is requested by a user using the user terminal based on a signal from the user terminal;
a converting unit for converting the connection destination information included in a connection request received from the user terminal into a corresponding telephone number by referring to said storing unit when the user requests a predetermined service; and
a call processing unit for connecting the user terminal and the information providing device by transmitting to a radio network controller the telephone number obtained by the conversion.

2. The base station apparatus according to claim 1, wherein
the information providing device comprises a camera which outputs video image data, and
the connection destination information is information which specifies a name of a place at which the camera is installed.

3. The base station apparatus according to claim 1, wherein
said storing unit is updated when a new information providing device is connected to the wireless communication system or when the existing information providing device is removed from the wireless communication system.

4. A base station apparatus accommodating an information resource system in a wireless communication system, comprising:
a managing unit for managing a congestion state of the information resource system;
a holding unit for holding auxiliary resource related to information resource provided by the information resource system; and
a responding unit, upon receiving a connection request to the information resource system from the user terminal, for connecting the user terminal to the information resource system when the information resource system is not congested, and for providing to the user terminal the auxiliary resource held in said holding unit when the information resource system is congested.

5. The base station apparatus according to claim 4, wherein
the information resource system comprises a camera which outputs video image data, and
the auxiliary information held in said holding unit is fixed image data corresponding to the video image data.

6. The base station apparatus according to claim 4, further comprising a requesting unit for periodically requesting the information resource providing system for the auxiliary resource.

7. The base station apparatus according to claim 4, wherein
the information resource providing system comprises a first terminal device and a second terminal device to which different telephone numbers are assigned for transmitting the information resource, and
if the first terminal device is busy when there is a connection request to the first terminal device from the user terminal, said responding unit connects the user terminal to the second terminal device.

8. A base station apparatus accommodating a user terminal in a wireless communication system, comprising:
storing means for storing connection destination information specifying an information providing device and a corresponding telephone number assigned to the information providing device;
detecting means for detecting a service which is requested by a user using the user terminal based on a signal from the user terminal;
converting means for converting the connection destination information included in a connection request received from the user terminal into a corresponding telephone number by referring to said storing means when the user requests a predetermined service; and
call processing means for connecting the user terminal and the information providing device by transmitting to a radio network controller the telephone number obtained by the conversion.

9. A base station apparatus accommodating an information resource system in a wireless communication system, comprising:
managing means for managing a congestion state of the information resource system;
holding means for holding auxiliary resource related to information resource provided by the information resource system; and
responding means, upon receiving a connection request to the information resource system from the user terminal, for connecting the user terminal to the information resource system when the information resource system is not congested, and for providing to the user terminal the auxiliary resource held in said holding means when the information resource system is congested.
